(19) United States
(12) Patent Application Publication
(10) Pub. No.: US 2007/0006225 A1
(43) Pub. Date: Jan. 4, 2007

(54) System and method for converting a target computing device to a virtual machine

(75) Inventors: Brittney Diane McAlister, Issaquah, WA (US); Eric Joseph Winner, Woodinville, WA (US); Marios Zikos, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/165,753

(22) Filed: Jun. 23, 2005

(51) Int. Cl. G06F 9/455

(52) U.S. Cl. 718/1

(57) ABSTRACT

A system and method for converting a target computing device to a virtual machine are provided. An assessment of the physical and software assets of a target computing device are obtained. A data image of the target computing device is deployed on an instance of a virtual machine. The virtual machine adjusted to correspond to the physical and software assets of the target computing device.

### FIELD OF THE INVENTION

In general, the present invention relates to computer software and communication networks, and, in particular, to a system and method for converting a target machine to a virtual machine.

### BACKGROUND OF THE INVENTION

Generally described, virtual machines correspond to software applications on a computing device that emulate the functionality of one or more hardware devices. In one embodiment, virtual machines may be utilized to mimic the characteristics of a specific piece of hardware. For example, a virtual machine may be used on a computing device having a processor from a first manufacturer to mimic the characteristics of a processor from a second manufacturer. In a more complex embodiment, a virtual machine can be configured to emulate an entire computing device by emulating specific hardware characteristics and being configured with specific software applications. For example, a host computing device may host multiple virtual machines that are configured to emulate the same hardware components but utilize different operating systems (e.g., version or manufacturer). In another example, a host computing device, such as a Web server, may host multiple virtual machines in which each virtual machine acts as an “independent” Web server with specific hardware and software configurations.

In one application, virtual machines may be utilized to emulate another computing device, such as a physical computing device or other virtual machine. For example, a user or system administrator may wish to “convert” a physical machine to a virtual machine that emulates a similar hardware configuration to the physical machine. Current approaches to convert target computing devices (e.g., a physical machine) to virtual machines corresponds to a multi-step approach that requires manual intervention from a knowledgeable user. Thus, the conversion process can be cumbersome and inefficient.

Thus, there is a need for a system and method for converting target computing devices to virtual machines in a more efficient manner.

### SUMMARY OF THE INVENTION

A system and method for converting a target computing device to a virtual machine are provided. An assessment of the physical and software assets of a target computing device are obtained. A data image of the target computing device is deployed on an instance of a virtual machine. The virtual machine adjusted to correspond to the physical and software assets of the target computing device.

In accordance with an aspect of the present invention, a method for configuring a virtual machine to correspond to a target computing device is provided. In accordance with the method an assessment of physical and software assets of the target computing device is obtained. A data image of the target computing device is captured. Additionally, a configuration of the virtual machine is automatically adjusted based upon the assessment of the physical and software assets of the target computing device.

In accordance with another aspect of the present invention, a method for converting a target computing device to a virtual machine is provided. In accordance with the method, an assessment of physical and software assets of the target computing device is obtained. An image of the target computing device is ported to the virtual machine. A configuration of the virtual machine is automatically adjusted based upon the assessment of the physical and software assets of the target computing device. The target computing device is shut down and the virtual machine is brought on line.

In accordance with a further aspect of the present invention, a computer-readable medium having computer-executable components for configuring a virtual machine to correspond to a target computing device is provided. The computer-executable components include a target computing device assessment component for generating an assessment of target machine hardware and software assets. The computer-executable components also include a virtual machine creation component for initializing an instance of a virtual machine and for deploying a data image of the target computing device on the virtual machine. The computer-executable components further include a virtual machine configuration component for configuring one or more aspects of the virtual machine according to the target machine hardware and software assets.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a system for converting target computing devices to virtual machines including one or more target computing devices, a configuration server and a host server hosting one or more virtual machines in accordance with the present invention;

FIG. 2 a block diagram of the system of FIG. 1 illustrating the assessment of a target computing device and the configuration of a virtual machine to correspond to the target computing device in accordance with an aspect of the present invention;

FIG. 3 is a flow diagram illustrative of a target machine conversion routine in accordance with the present invention; and

FIG. 4 is a flow diagram illustrative of a target computing device physical and software asset assessment sub-routine in accordance with the present invention; and

FIG. 5 is a flow diagram illustrative of a virtual machine configuration update sub-routine in accordance with the present invention.

### DETAILED DESCRIPTION OF THE PREFERRED EMBODIMENT

Generally described, the present invention relates to a system and method for converting a target computing device to a virtual machine. More specifically, the present invention corresponds to a system and method for assessing target machine assets, porting them to a virtual machine and updating the virtual machine configuration. Although the present invention will be described with regard to a system of target computing devices, configuration servers, hosting servers and their respective functionality, the disclosed embodiments are illustrative in nature and should not be construed as limiting.

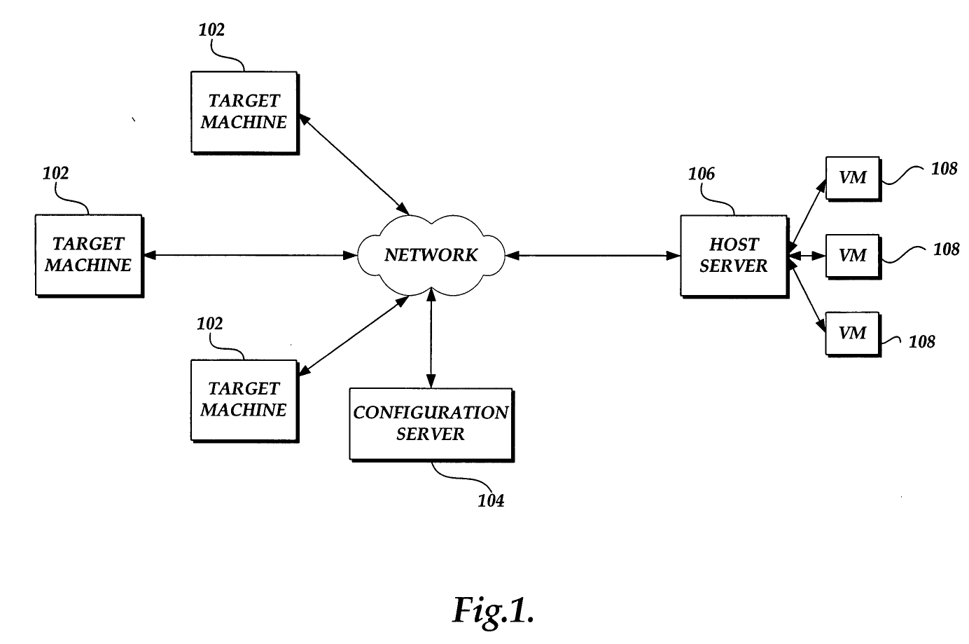

FIG. 1 is a block diagram illustrative of a system 100 for converting target computing devices to virtual machines. The system 100 includes one or more target computing devices 102 in communication with a communication network, such as a local area network or a wide area network. In an illustrative embodiment of the present invention, the target computing devices 102 can correspond to physical computing devices, such as server computing devices, personal computing devices, mobile computing devices, mobile telephones, and/or any device having computing device functionality. Additionally, one or more target computing devices 102 can correspond to previously configured virtual machines hosted by a computing device. As will be described in greater detail below, each of the target computing devices 102 include various physical and software assets.

The system 100 includes a configuration server 104 in communication with the communication network. The configuration server 104 includes one or more software components for obtaining an assessment of the physical and software assets for target computing devices 102 and for initializing the creation of a virtual machine to emulate the target machine. Additionally, the configuration server 104 includes one or more software components for capturing a data image of the target machines 102 and deploying the image on the virtual machines. The system 100 further includes one or more host server 106 that include one or more virtual machines 108. In an illustrative embodiment of the present invention, each virtual machine can be configured with hardware and software assets to emulate a target computing device 102. Additionally, the host server 106 can include software components for updating the configuration of the virtual machine based upon the assessment of a target machine 102 and the particular limitations/implementation of the virtual machine 108, as will be described in greater detail below.

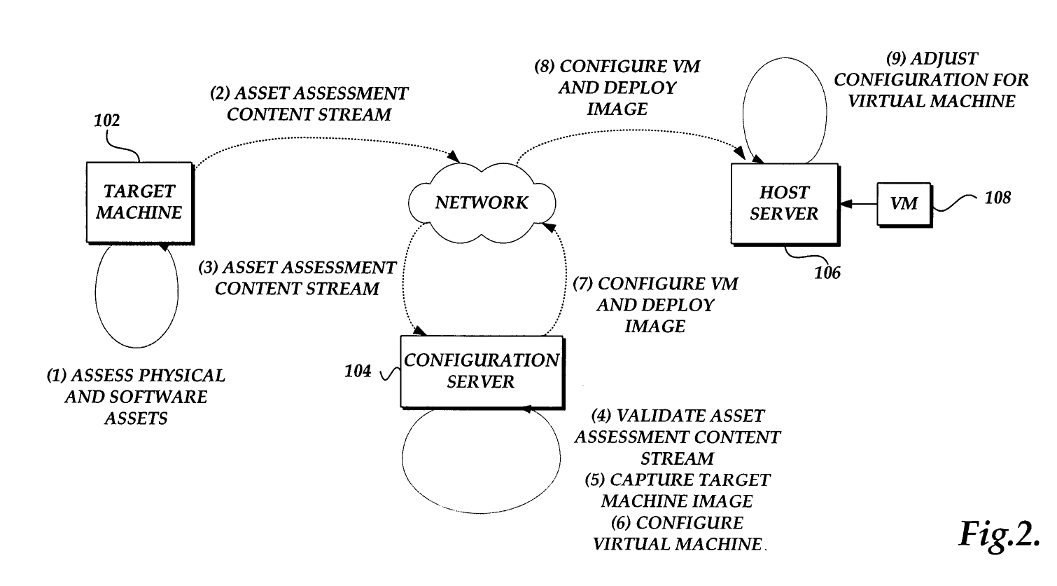

With reference now to FIG. 2, an illustrative process for converting a target computing device 102 to a virtual machine 108 will be described. The process begins with the assessment of various physical and software assets of the target machine 102. In an illustrative embodiment of the present invention, the configuration server 104 transmits a software module and/or instructions to the target machine to collect a set of physical and software assets. The software module/instructions may utilize one or more utilities provided by the operating system to collect the asset information. Alternatively, the target machine 102 may also utilize additional third party software components. Once the physical and software assets are collected, they are transmitted over the communication network to the configuration server 104.

The configuration server 104 obtains the hardware and software asset from the target computing device 102 and validates the assessment. The validation can correspond to verification that the assessment data is proper and/or whether the target computing device 102 can be emulated by a virtual machine 108. The configuration server 104 then identifies a target virtual machine 108 by instantiating the creation of the virtual machine on a host server 106 or identifying an existing virtual machine on a host server. The configuration server 104 then captures a data image of the data stored on the target computing device 102. In an illustrative embodiment of the present invention, the configuration server 104 may copy the data image to a data store associated with configuration server 104. Alternatively, the configuration server 104 may utilize one or more services for creating a virtual volume for temporarily storing the data image. The configuration server 104 then transmits a virtual machine configuration and data image deployment to the host server 106.

Upon receipt of the virtual machine configuration and data image deployment, the host server updates the configuration of the virtual machine to correspond to the target computing device hardware and software assessment and the limitations of the virtual machine. As will be explained in greater detail, the host server 106 can adjust the configuration of the virtual machine to correspond to operating environment differences, driver incompatibilities and/or service incompatibilities. Once the virtual machine configuration has been updated, the data image is ported to the virtual machine. The target machine 102 can be shut down and the virtual machine brought on line.

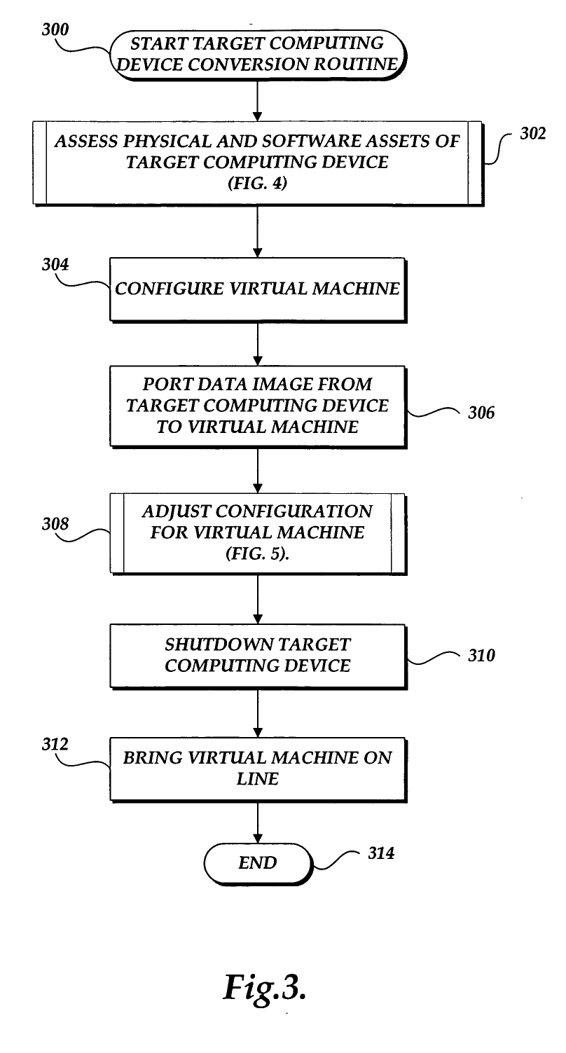

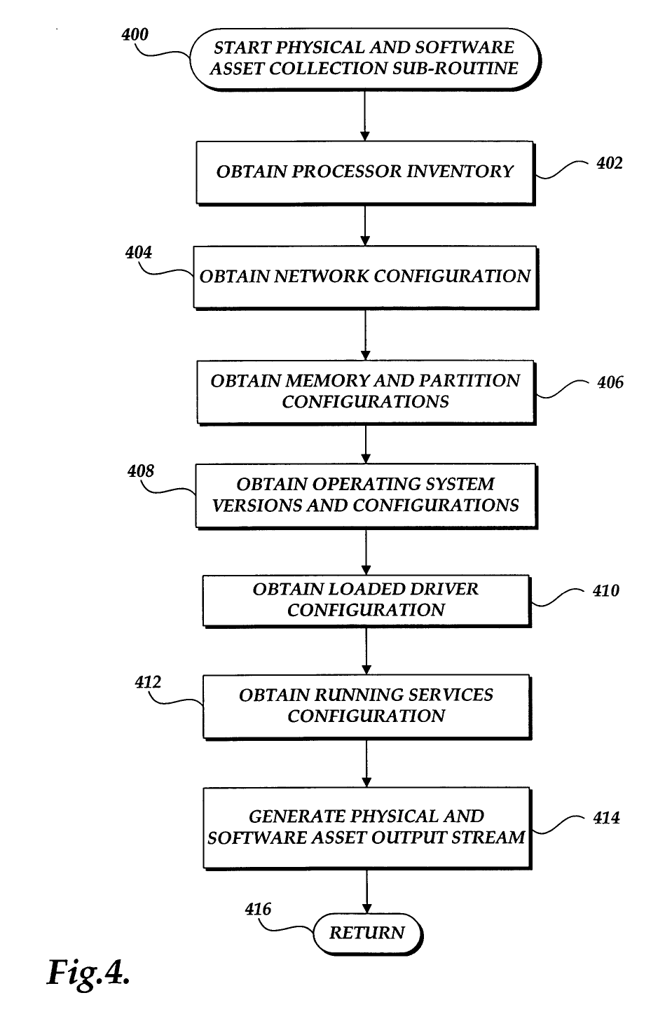

With reference now to FIGS. 3-5 illustrative routines for converting a target computing device 102 to a virtual machine 108 will be described. With reference to FIG. 3, a routine 300 for converting a target computing device 102 to a virtual machine 108 will be described. At block 302, the physical and software assets of the target computing device 102 are assessed. In an illustrative embodiment of the present invention, the physical and software assessment is collected at the target computing device 102 and transmitted to the configuration server 104. The collection of the physical and software assets will be described below with regard to sub-routine 400 (FIG. 4). At block 304, a virtual machine 108 is configured. In an illustrative embodiment of the present invention, the configuration server 108 identifies a host computing device 106 that can instantiate a virtual machine 108 capable of emulating the target computing device 102. The configuration server 104 can utilize various criteria, such as load balancing and/or consolidation, in selecting and instantiating a virtual machine 108 on a particular host server 106.

At block 306, the configuration server 104 ports the data image from the target computing device 102 to the virtual machine 108. In an illustrative embodiment of the present invention, the configuration server 104 can utilize one or more services for capturing the data image of the target computing device 102. For example, the configuration server 104 can utilize a network-based service to capture the data image and store the data image in a “virtual hard drive” on the network for transfer to the virtual machine. Alternatively, the configuration server 104 may capture and store the image locally. By capturing the data image from the target computing device 102, the virtual machine 108 will have the exact same software configurations as the target computing device.

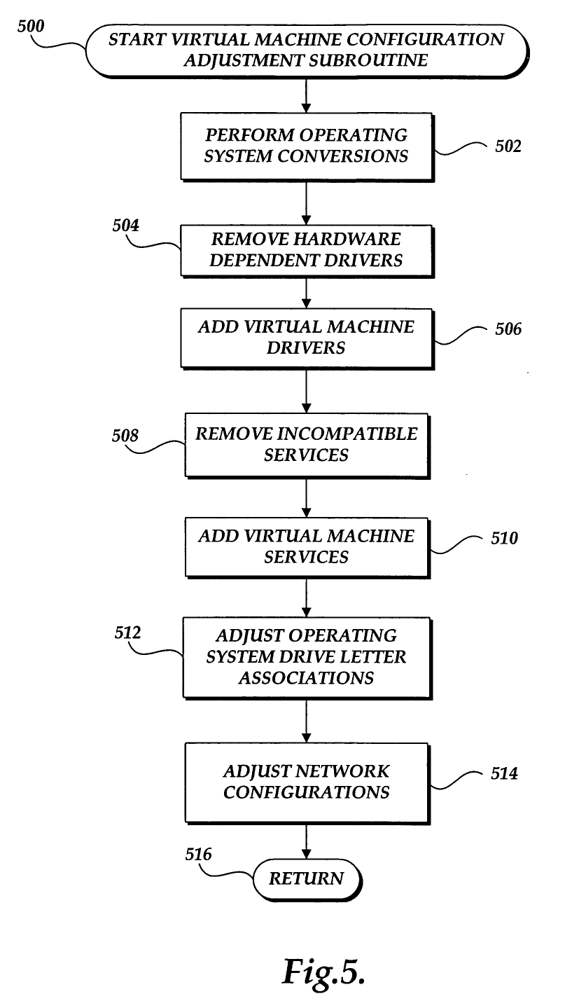

At block 308, the host server 106 adjusts the configuration of the virtual machine 108 based upon the hardware and software assessment and the particular limitations of the virtual machine. The adjustment of the virtual machine configuration will be described with regard to sub-routine 500 (FIG. 5). At block 310, the target computing device 102 is shut down or otherwise disconnected from the communication network. At block 312, the virtual machine 108 is brought on-line and connected to the communication network. At block 314, the routine 300 terminates.

With reference now to FIG. 4, a sub-routine 400 for generating an assessment of various physical and software assets of a target machine 102 corresponding to block 302 (FIG. 3) will be described. At block 402, a processor inventory is obtained. In an illustrative embodiment of the present invention, the processor inventory corresponds to a number and type of processor inventory. At block 404, a network configuration is obtained. In an illustrative embodiment of the present invention, the network configuration can correspond to the number of network interface cards and specific configuration information for each identified card. At block 406, memory and partition configuration information is obtained. In an illustrative embodiment of the present invention, the memory and partition configuration can include an identification of the memory components of the target computing device including the size of RAM and hard drives. Additionally, the configuration information can include additional information about some of the memory components, such as the hard drives, including the number of partitions, the partition types, partition sizes, and the number of hard drives in each partition.

At block 408, operating system version and configuration information is obtained. In an illustrative embodiment of the present invention, the operating system configuration information can include an identification of particular operating system version. Additionally, the operating system configuration information can include an identification of particular patches, updates and/or additional modifications to the identified version of the operating system. At block 410, an identification of loaded drivers is obtained. In an illustrative embodiment of the present invention, the identification of loaded drivers can include an identification of hardware-specific drivers. At block 412, an identification of running services is collected. At block 414, an output stream of the hardware and software assessment is generated for transmission to the configuration server. In an illustrative embodiment of the present invention, the output stream can correspond to an XML document. At block 416, the sub-routine 400 returns.

With reference now to FIG. 5, a sub-routine 500 for adjusting the configuration of a virtual machine 108 corresponding to block 308 (FIG. 3) will be described. At block 502, the host computing device 106 performs any operating system and hardware conversions. In an illustrative embodiment of the present invention, the virtual machine 108 may have limitations as to the minimum and/or maximum of processors that it can support. Accordingly, if the target computing device 102 hardware assessment indicates a number of processors that are above/below the limitations of the virtual machine 108, the host server 106 may convert the assessment to be compatible with the virtual machine. Additionally, the host server 106 may also make additional operating system conversions to support the hardware limitations of the virtual machine 108.

At block 504, the host server 106 removes any hardware dependent drivers and adds any virtual machine drivers at block 506. In an illustrative embodiment of the present invention, hardware dependent drivers on the target computing device 102 may not work properly on the virtual machine and can be replaced by virtual machine drivers. Additionally, the host server 106 may add additional drivers to correspond any hardware conversions corresponding to block 502. Further, the host server 106 may add drivers required for operation of the virtual machine 108. In a similar fashion, at block 508, the host server 106 removes any incompatible services and adds any virtual machine services at block 510.

At block 512, the host server 106 may adjust operating system drive letter associations. In an illustrative embodiment of the present invention, the target computing device 102 may have specific driver letter associations. However, the virtual machine 108 may utilize a different order in assigning driver letters during the initial boot of the operating system on the virtual machine. Accordingly, the host server 106 may maintain the target computing device's previous drive letter associations. At block 514, the host server 106 adjusts the network configuration for the virtual machine 108. In an illustrative embodiment of the present invention, the host server 106 can configure the virtual machines network interface cards to match the target computing device's configuration and/or make any adjustments. In an illustrative embodiment of the present invention, blocks 512 and 514 may occur during the initial boot of the operating system on the virtual machine 108. At block 516, the sub-routine 500 returns.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. A method for configuring a virtual machine to correspond to a target computing device, the method comprising:
obtaining an assessment of physical and software assets of the target computing device;
capturing a data image of the target computing device; and
automatically adjusting a configuration of the virtual machine based upon the assessment of the physical and software assets of the target computing device.

2. The method as recited in claim 1, wherein obtaining an assessment of physical and software assets of the target computing device includes obtaining information selected from the group consisting of: a target computing device processor inventory, a target computing device network configuration, a target computing device memory and partition configuration, a target computing device driver configuration and a target computing device service configuration.

3. The method as recited in claim 1 further comprising:
generating an instance of a virtual machine on a host computing device; and
deploying the captured data image of the target computing device on the virtual machine.

4. The method as recited in claim 1, wherein automatically adjusting a configuration of the virtual machine based upon the assessment of the physical and software assets of the target computing device includes:
performing operating system correlations between a target machine operating system configuration and a virtual machine operating system configuration;
performing loaded driver conversions; and
performing running services conversions.

5. The method as recited in claim 4, wherein performing loaded driver conversions includes:
removing any hardware-specific driver; and
adding any drivers associated with the virtual machine.

6. The method as recited in claim 4, wherein performing running services conversions includes removing any incompatible services.

7. The method as recited in claim 4 automatically adjusting a configuration of the virtual machine based upon the assessment of the physical and software assets of the target computing device further comprises:
adjusting volume drive letters assignments; and
configuring network communications on the virtual machine.

8. A method for converting a target computing device to a virtual machine, the method comprising:
obtaining an assessment of physical and software assets of the target computing device;
porting an image of the target computing device to the virtual machine;
automatically adjusting a configuration of the virtual machine based upon the assessment of the physical and software assets of the target computing device;
shutting down the target computing device; and
bringing the virtual machine on line.

9. The method as recited in claim 8, wherein obtaining an assessment of physical and software assets of the target computing device includes obtaining information selected from the group consisting of: a target computing device processor inventory, a target computing device network configuration, a target computing device memory and partition configuration, a target computing device driver configuration and a target computing device service configuration.

10. The method as recited in claim 8, wherein porting an image of the target computing device to the virtual machine includes:
generating an instance of a virtual machine on a host computing device;
capturing a data image of the target computing device; and
deploying the captured data image of the target computing device on the virtual machine.

11. The method as recited in claim 8, wherein automatically adjusting a configuration of the virtual machine based upon the assessment of the physical and software assets of the target computing device includes:
performing operating system correlations between a target machine operating system configuration and a virtual machine operating system configuration;
performing loaded driver conversions; and
performing running services conversions.

12. The method as recited in claim 11, wherein performing loaded driver conversions includes:
removing any hardware-specific driver; and
adding any drivers associated with the virtual machine.

13. The method as recited in claim 11, wherein performing running services conversions includes removing any incompatible services.

14. The method as recited in claim 11 automatically adjusting a configuration of the virtual machine based upon the assessment of the physical and software assets of the target computing device further comprises:
adjusting volume drive letters assignments; and
configuring network communications on the virtual machine.

15. A computer-readable medium having computer-executable components for configuring a virtual machine to correspond to a target computing device, the components comprising:
a target computing device assessment component for generating an assessment of target machine hardware and software assets;
a virtual machine creation component for initializing an instance of a virtual machine and for deploying a data image of the target computing device on the virtual machine; and
a virtual machine configuration component for configuring one or more aspects of the virtual machine according to the target machine hardware and software assets.

16. The computer-readable components as recited in claim 15, wherein the target computing device assessment component obtains information selected from the group consisting of: a target computing device processor inventory, a target computing device network configuration, a target computing device memory and partition configuration, a target computing device driver configuration and a target computing device service configuration.

17. The computer-readable components as recited in claim 15, wherein the virtual machine configuration component performs operating system correlations between a target machine operating system configuration and a virtual machine operating system configuration.

18. The computer-readable components as recited in claim 15, wherein the virtual machine configuration component removes any hardware-specific drivers and loads any drivers associated with the virtual machine.

19. The computer-readable components as recited in claim 15, wherein the virtual machine configuration component removes any incompatible services.

20. The computer-readable components as recited in claim 15, wherein the virtual machine configuration component performs volume letter associations and network configurations.
